(19) United States
(12) Patent Application Publication
(10) Pub. No.: US 2024/0220135 A1
(43) Pub. Date: Jul. 4, 2024

(54) DYNAMICALLY ADAPTIVE AUTOSCALING FOR OBJECT STORAGE

(71) Applicant: Red Hat, Inc., Raleigh, NC (US)

(72) Inventors: Yuval Lifshitz, Ra'anana (IL); Chen Wang, New York, NY (US); Huamin Chen, Westford, MA (US)

(21) Appl. No.: 18/091,586

(22) Filed: Dec. 30, 2022

(51) Int. Cl. G06F 3/06

(52) U.S. Cl. CPC G06F 3/0626; G06F 3/0644; G06F 3/0673

(57) ABSTRACT

The present disclosure is a new, innovative system and methods for dynamically adaptive autoscaling. An example system includes a memory and at least one processing device in communication with the memory. The processing device is configured to receive a request at a storage gateway microservice's request queue and process the request at the storage gateway microservice. The processing device is configured to store or retrieve data related to the processed request using a storage backend microservice. The processing device is configured to report to an observer, in a fixed interval, input, output, and resource usage metrics related to the processing of the request and storing or retrieving data. The observer is configured to determine a scaling decision using the metrics and transmit it to at least one scaler, which performs a scaling action on the storage gateway microservice, storage backend microservice, or both based on the scaling decision.

### BACKGROUND

Microservices that perform storage need to be capable of handling a variety of payloads that result in different performance characteristics. For example, in some instances, an object storage gateway microservice may experience payloads that are resource intensive, such as if the microservice is required to perform a processing intensive activity, such as compression. In these instances, system performance may improve from vertical scaling of the object storage gateway microservice, such as increasing the allocation of processing and memory resources of the object storage gateway microservice. In other instances, the object storage gateway microservice may experience payloads that are not resource intensive, such as the microservice may not perform any processing intensive activity and just accumulate requests in a request queue. In these instances, system performance may improve from horizontal scaling of the object storage gateway microservice, such as increasing the number of instances of the object storage gateway microservice in order to reduce system latency. Moreover, in many computer systems, vertical and horizontal scalers are used to better manage the computing resources of the system based on the payload of the system.

### SUMMARY

The present disclosure provides a new and innovative system and methods for the dynamically switching between vertical and horizontal scalers in order to adapt to the payload of an object storage system.

In an example, a method includes receiving a request at a request queue of a storage gateway microservice. The method also includes processing the request at the storage gateway microservice. Processing the request may include conducting compression, encryption, or some other data processing, or it may simply involve sending the request to a storage backend microservice. The method further includes storing or retrieving data related to the request using a storage backend microservice. Additionally, the method includes reporting to an observer, in a fixed interval, input characteristics, output characteristics, and resource usage characteristics related to the processing of the request and storing or retrieving of data. The observer is configured to determine a scaling decision based on the reported metrics and transmit the scaling decision to a scaler, which performs a scaling action on the storage gateway microservice, the storage backend microservice, or both based on the scaling decision.

In an example, a system includes a memory and at least one processing device in communication with the memory. The at least one processing device is configured to receive a request at a request queue of a storage gateway microservice. The processing device, is also configured process the request at the storage gateway microservice. Additionally, the processing device is further configured to store or retrieve data related to the processed request using a storage backend microservice. The processing device is also configured to report to an observer, in a fixed interval, input metrics, output metrics, and resource usage metrics related to the processing of the request and the storing or retrieving of data. The observer is configured to determine a scaling decision based on the reported metrics and transmit the scaling decision to a scaler, which performs a scaling action on the storage gateway microservice, the storage backend microservice, or both based on the scaling decision

In an example, a non-transitory machine readable medium stores code, which when executed by at least one processor is configured receive a request at a request queue of a storage gateway microservice; process the request at the storage gateway microservice; store or retrieve data related to the processed request using a storage backend microservice; and, report input metrics, output metrics, and resource usage metrics related to the processing of the request and storing of data to an observer, wherein the observer is configured to determine a scaling decision based on the reported metrics and transmit the scaling decision to a scaler.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates an example embodiment of a system for dynamically switching between horizontal and vertical scalers.

FIG. 2 illustrates the system flow of an example embodiment of a system for dynamically switching between horizontal and vertical scalers.

FIG. 3 illustrates the system flow of an example embodiment of a system for dynamically switching between horizontal and vertical scalers.

FIG. 4 is a block flowchart illustrating a method for dynamically switching between a vertical and horizontal scalers

FIG. 5 is a flow diagram illustrating an example embodiment according to the present disclosure of a method for dynamically switching between a vertical and horizontal scalers.

FIG. 6 illustrates an example embodiment of a system for dynamically switching between horizontal and vertical scalers.

### DETAILED DESCRIPTION OF EXAMPLE EMBODIMENTS

In many computer systems, vertical and/or horizontal scalers are used to better manage the computing resources of the system based on the payload of the system. Generally, vertical scalers and horizontal scalers work independently to determine the appropriate resource allocation for an application or microservice. Vertical scalers determine the size of containers, such as the processor utilization and memory usage limits, for each instance of a microservice, and horizontal scalers determine the number of instances for each deployment of a microservice. When using vertical and horizontal scalers together in an application, the payload characteristics of the system can result in instances where vertical scalers try to reduce the allocated resources of each instance of a microservice based on resource utilization metrics, while horizontal scalers simultaneously try to scale out the number of instances of a microservice to improve another performance characteristic, such as reducing system latency. This results the horizontal scaler and vertical scaler working against each other simultaneously. The collision of these mechanisms results in churn and decreases the overall system throughput and efficiency. Accordingly, there is a need for an efficient system and method for using both vertical and horizontal scaling that adapts to the payload characteristics of the system to maximize performance of an object storage system.

The present disclosure improves the overall efficiency of autoscaling systems for object storage by providing for the dynamic switching between vertical and horizontal scalers based on the system payload, where an observer receives system metrics from a number of microservices in order to determine a scaling decision that defines a scaling action to be performed by at least one scaler. The observer coordinates the different scalings of the different microservices based on performance metrics of the entire system (e.g. both a storage gateway microservice and a storage backend microservice). As the observer functions as a common controller of both vertical and horizontal scalers, it is able to dynamically switch between the two scalers in order to better adapt to the payload of the system, while avoiding the issues of independently controlled scalers, such as a vertical scaler trying to scale down the system while the horizontal scaler tries to scale out the system. As such, a system and methods of dynamically adaptive autoscaling for object storage based on system performance metrics of multiple microservices, as determined by the system payload, is provided.

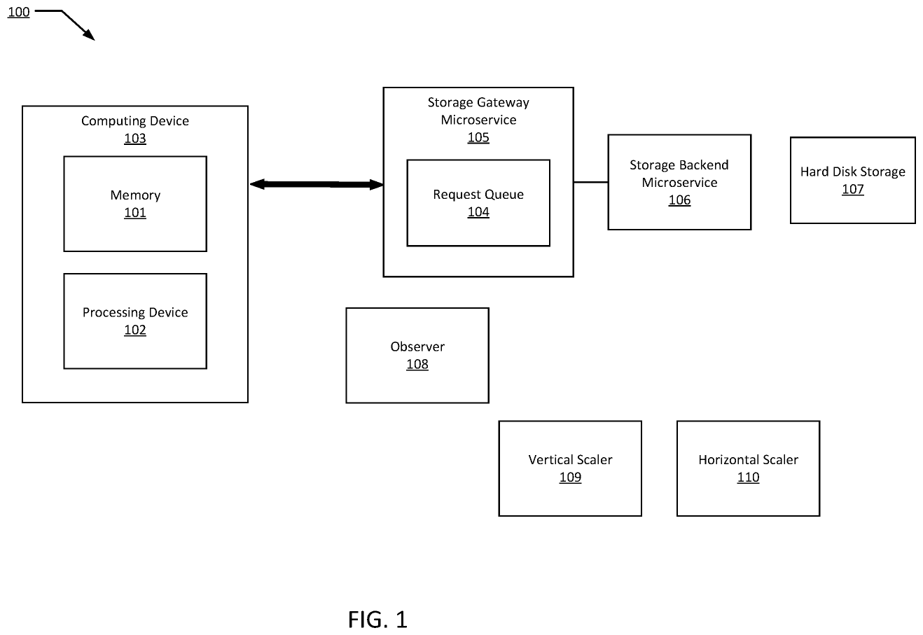

FIG. 1 illustrates an example embodiment of a system for dynamically switching between horizontal and vertical autoscalers to dynamically adapt to the payload of the system. A system 100 may include a memory 101 and at least one processing device 102 in communication with the memory 101. The processing device 102 may be a CPU, an ASIC, or any other similar device. The memory 101 and at least one processing device 102 may be the memory 101 and processing device 102 of a computing device 103.

The computing device 103 may send a request to the request queue 104 of a storage gateway microservice 105. In an example, the computing device 103 may send a request to the storage gateway microservice 105 that includes a request to store an uploaded image file to a permanent storage, such as hard disk storage 107, as an object using a storage backend microservice 106. The storage backend microservice 106 may be configured to store or retrieve an object and its metadata to hard disk storage 107, or some other permanent storage medium, such as solid-state storage.

The system 100 may also include an observer 108, which is configured to receive information regarding various system characteristics. These metrics may include resource usage characteristics, such as percentage of processor utilization or amount of memory utilization, of both the storage gateway microservice 105 and the storage backend microservice. Additionally, these metrics may include input characteristics of the request queue 104 of the storage gateway microservice 105, such as the number of requests in the request queue and the size of these requests. These metrics may also include output characteristics of the storage gateway microservice 105, such as response time, measured, for example, in milliseconds or microseconds. The response time may be measured as the time from which a request is received at the request queue 104 of the storage gateway microservice 105 to the time at which the storage gateway microservice 105 receives a notification from the storage backend microservice 106 the storing of an object is complete.

These metrics may be reported to the observer 108 in a fixed interval by the storage gateway microservice 105 and storage backend microservice 106. For example, the storage gateway microservice 105 may report to the observer 108 on the size of its request queue 104, i.e. the number of operations requested, in a fixed interval of every 5 seconds. The reporting may be implemented through a scraper that retrieves metrics reported internally at either the storage gateway microservice 105 or storage backend microservice 106 or both, such as the Prometheus monitoring framework for Kubernetes. This fixed interval may be reconfigurable by the observer 108, or externally by a system user, based on the rate of change of the received metrics. For instance, if the observer 108 receives metrics that are changing very rapidly, the observer 108 may determine that the fixed interval should be shortened so that metrics are reported more frequently. Alternatively, the observer 108 may determine that the fixed interval can be extended based on the received metrics changing very little between reports.

The observer 108 may utilize these characteristics to determine a scaling decision, which it transmits to a vertical scaler 109, horizontal scaler 110, or both. The scaling decision results in one or both of the vertical 109 and horizontal scalers 110 performing a scaling action on either the storage gateway microservice 105 or the storage backend microservice 106. As such, the observer 108 functions as a common controller of both the vertical scaler and horizontal scaler in order to eliminate instances where the vertical scaler 109 and horizontal scaler 110 are working against each other, improving overall system 100 efficiency.

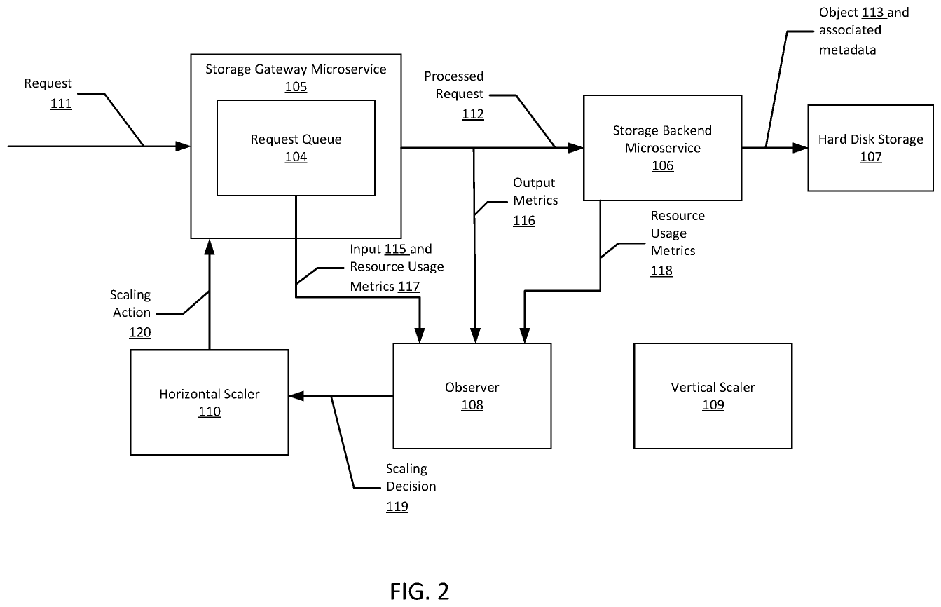

FIG. 2 illustrates an example system flow diagram according at an aspect of the present invention. The storage gateway microservice 105 may receive a request 111 at the request queue 104. For example, the storage gateway microservice 105 may receive a request 111 to upload a video file for permanent storage in the hard disk storage 107 associated with the storage backend microservice 106. The storage gateway microservice 105 may process the request 111, for example the storage gateway microservice 105 may perform compression or encryption on the video file, before transmitting the processed request 112 to the storage backend microservice 106. The storage gateway microservice 105 and storage backend microservice 106 may communicate with one another using suitable inter storage interface data transfer protocols known in the art, such as SCSI. The storage backend microservice 106 may store the compressed or encrypted video file as an object and associated metadata 113 in hard disk storage 107.

The observer 108 may receive a variety of metrics related to system performance, which may include input metrics 115, such as the size of the request queue, resource usage metrics 117, such as processor utilization or memory utilization, and output metrics 116, such as response time, from the storage gateway microservice 105 as well as resource usage metrics 118 from the storage backend microservice 106. Based on these various metrics, the observer 108 determines a scaling decision 119 which it transmits to a scaler, such as a vertical scaler 109 or a horizontal scaler 110, which performs a scaling action 120 on the storage gateway microservice 105, the storage backend microservice 106, or both based on the scaling decision 119. For example, if the received input and output metrics 115, 116 indicate to the observer that the queue size is increasing at a greater rate than the response time, the observer 108 may determine that more instances of the storage gateway microservice 105 are needed to more quickly service the request queue 104. Additionally, if the received input and output metrics 115,116 indicate to the observer 108 that the response time is increasing at a greater rate than the request queue 104, the observer may determine that more processing or memory resources need to be allocated to the storage backend microservice 106 in order to reduce the amount of time spent at the hard disk storage 107.

The storage gateway microservice 105 or storage backend microservice 106 may be performing time-intensive and processor-intensive actions, while additional requests are received at the request queue 104 of the storage gateway microservice 105. For example, the storage gateway microservice 105 may be performing compression on a large video file before storing, while a large number of requests, e.g. request 111, to store text files are received at the request queue 104 of the storage gateway microservice 105. As a result, the observer 108 may dynamically determine a scaling decision 119 that states that the horizontal scaler 110 needs scale out more storage gateway microservice 105 instances to process the large number of text storage requests and service the request queue 104. The observer 108 may transmit the scaling decision 119 to the horizontal scaler 110, which then performs a scaling action 120, for example, scaling out the storage gateway microservice 105 to provide more instances to service the request queue 104.

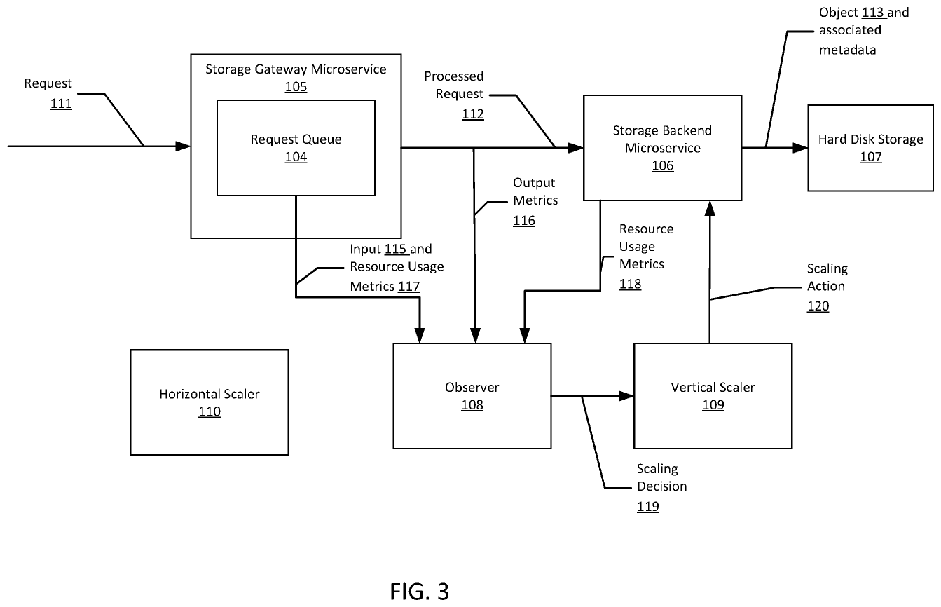

FIG. 3 illustrates an additional example system flow diagram according at an aspect of the present invention. The storage gateway microservice 105 may receive a request 111 at the request queue 104 of a storage gateway microservice 105, for example to store a large, uncompressed video file in hard disk storage 107. The storage gateway microservice 105 may process the request and forward it 112 to the storage backend microservice 106. Based on the resource usage metrics 118, storing a large video file may be a processor intensive action for the storage backend microservice 106. Therefore, based on the received input metrics 115, output metrics 116 and resource usage metrics 117, 118 reported to the observer 108, the observer 108 may dynamically determine a scaling decision 119 regarding the needs of the storage backend microservice 106. For example, the resource usage metrics 118 may report to the observer 108 that in storing the large video file, the storage backend microservice 106 exceeds a threshold utilization percent of the processing device, for instance the storage backend microservice 106 may be utilizing more than seventy percent of its allocated processing resources. Based on these metrics 118, the observer 108 may determine a scaling decision 119 that it transmits to a vertical scaler 109, which performs a scaling action 120 to scale up the processing resources allocated the storage backend microservice 106.

In additional embodiment of the present disclosure, the dynamic nature of the payload of the system may result in a scaling decision that comprises multiple scaling decisions. For example, the payload of the system may begin with a number of requests that represent resource intensive processes to the storage backend microservice 106, such as requests to store large video files, followed by a number of requests that represent resource intensive processes to the storage gateway microservice 105, such as a large number of requests to store text files. Based on the metrics of the system received by the observer 108, the observer 108 may determine a scaling decision that contains a scaling decision defining a scaling action that results in additional computing resources being allocated to the storage backend microservice 106 and a scaling decision defining a scaling action that results in the creation of multiple new instances of the storage gateway microservice 105. In other words, the scaling decision determined by the observer 108 may be transmitted to both a vertical scaler 109 and horizontal scaler 110, such that the scaling actions taken by the scalers results in the storage gateway microservice 105 being scaled “out” and the storage backend microservice 106 being scaled “up.”

In an additional example embodiment of the present disclosure, the payload of the system may begin with a relative large number of heavy jobs, or requests that will be resource intensive, followed by a smaller number of smaller jobs, or requests that will not be resource intensive. In this example, the observer 108, based on the received metrics, may initially determine a scaling decision that defines a scaling action that results in the creation of multiple new instances of the storage gateway microservice 105 in order to process the large number of requests received. However as the payload changes and is processed, the observer 108 may determine a scaling decision that defines a scaling action that results in additional computing resources being allocated to the storage backend microservice to complete the large number of heavy jobs and a scaling action that results in the reduction of instances of the storage gateway microservice 105 as the payload no longer requires as many instances of the storage gateway microservice 105. In other words, the scaling decision determined by the observer may be transmitted to both a vertical scaler and horizontal scaler, such that the scaling actions taken by the scalers results in the storage gateway microservice 105 being scaled “in” and the storage backend microservice 106 being scaled “up.” As the observer 108 monitors the performance of multiple microservices 105, 106 within the system and is able to control both vertical 109 and horizontal scalers 110 through the transmission of scaling decisions, the system 100 is able to adapt to payloads that would normally result in issues such as system churn and latency in system response by dynamically coordinating the scaling performed by the vertical 109 and horizontal scalers 108.

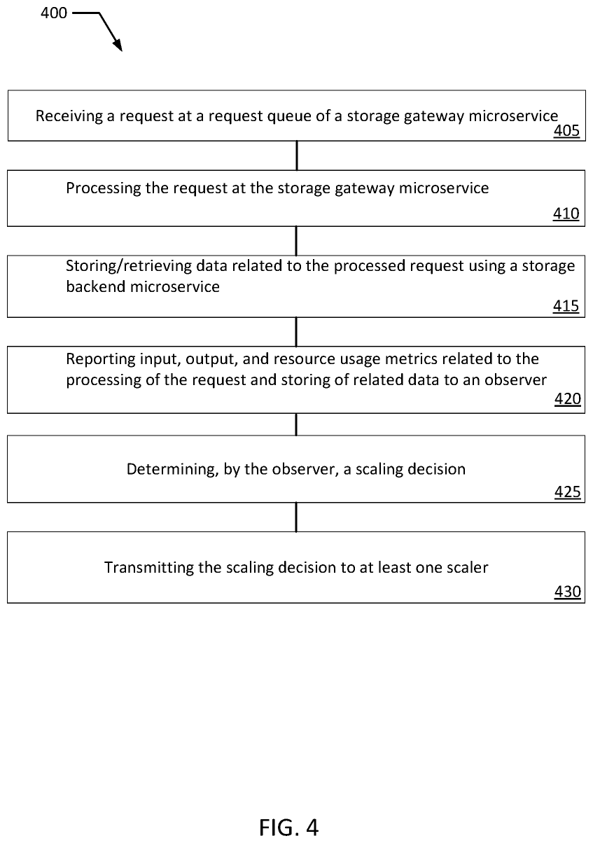

FIG. 4 is a flowchart illustrating a method for dynamically switching between a vertical and horizontal scalers. Although the example method 400 is described with reference to the flowchart illustrated in FIG. 4, it will be appreciated that many other methods of performing the acts associated with the method 400 may be used. For example, the order of some of the blocks may be changed, certain blocks may be combined with other blocks, blocks may be repeated, and some of the blocks described are optional. The method 400 may be performed by processing logic that may comprise hardware (circuitry, dedicated logic, etc.), software, or a combination of both.

In example method 400, a request is received at the request queue of a storage gateway microservice. For example, the storage gateway microservice 105 may receive a request at its request queue 104 to store a text file in permanent object storage, such as hard disk storage 107 (block 405). Example method 400 also includes processing the request at a storage gateway microservice. For example, the storage gateway microservice 105 may encrypt a text file when requested to store it in permanent storage 107 (block 410). Example method 400 additionally includes, storing (or retrieving) data based related to the processed request using a storage backend microservice. For example, a storage backend microservice 106 may write the data related to the processed request, i.e. the object and associated metadata to be stored, to a solid state drive in order to store the data and complete the received request (block 415).

Also, example method 400 includes reporting input, output, and resource usage metrics related to the processing of the request and storing of related data to an observer. The storage gateway microservice 105 may report to the observer 108 input characteristics such as the number of requests, or requested operations, in the request queue 104, and the size of these requests (block 420). Additionally, the storage gateway microservice 105 may report to the observer 108 on its resource usage, such as its allocated memory usage and allocated processing utilization (block 420). The storage gateway microservice 105 may also report to the observer 108 output characteristics of the system such as response time, or the time from when the request was received at the request queue 104 to when the storage backend microservice 106 notifies the storage gateway microservice 105 that it has finished storing the data and completed the request (block 420). The storage backend microservice 106 may report to the observer 108 on its resource usage, such as its allocated memory usage and allocated processing utilization (block 420).

Example method 400 also includes, determining, by the observer, a scaling decision. As described above, the observer 108 uses the reported metrics to dynamically determine a scaling decision. This scaling decision may be a result of the observer 108 calculating that one of the reported metrics exceeds a threshold, triggering the observer to determine a scaling decision that helps improve or adjust at least one of the reported metrics of the system (block 425). In example method 400, the observer transmits the scaling decision to at least one scaler. For example, the observer 108 may calculate that in encrypting a text file for storage the storage gateway microservice 105 exceeds a predetermined threshold of memory usage and determine a scaling decision that adjusts this metric. For instance, the observer 108 may transmit a scaling decision to a vertical scaler 109 (block 430), which performs a scaling action in allocating more memory resources for the storage gateway microservice 105.

In an additional embodiment, example method 400 may include additional processing of the request after retrieving data related to request using a storage backend microservice 106 (not pictured). For example, if the received request is a request to retrieve an encrypted text file from object storage, the storage gateway microservice 105 may process the request and as a result receive an encrypted text file retrieved from permanent storage by the storage backend microservice 106. The storage gateway microservice 105 may then perform additional processing of the request, such as decrypting the retrieved text file.

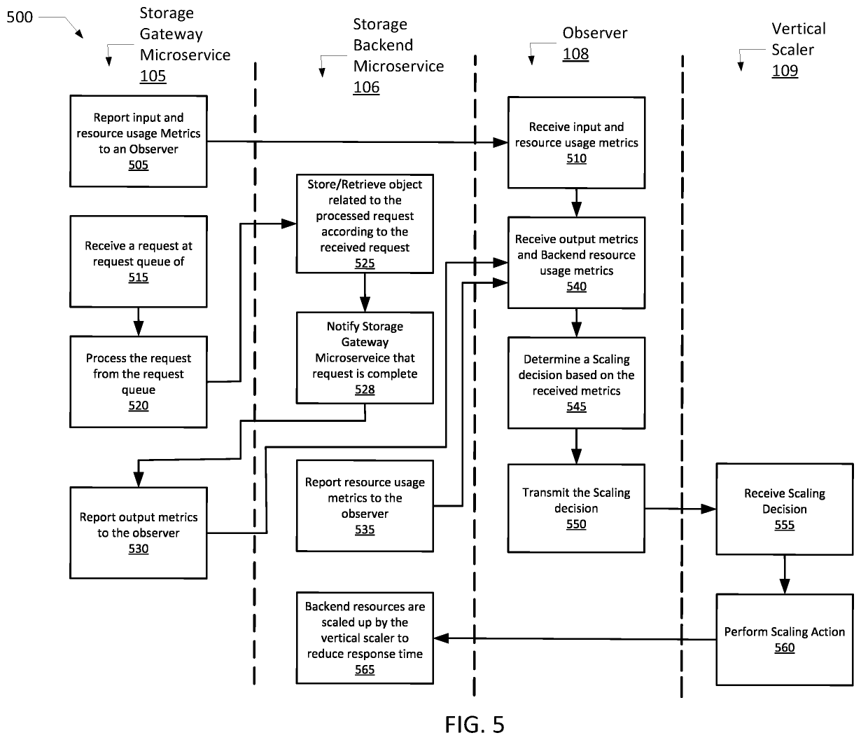

FIG. 5 is a flow diagram of an embodiment of the present disclosure. Although the example method 500 is described with reference to the flow diagram illustrated in FIG. 5, it will be appreciated that many other methods of performing the acts associated with the method may be used. For example, the order of some of the blocks may be changed, certain blocks may be combined with other blocks, blocks may be repeated, and some of the blocks described are optional. The method may be performed by processing logic that may comprise (e.g., circuitry, dedicated logic, etc.), software, or a combination of both. For example, a storage gateway microservice 105 and storage backend microservice 106 may report system input, sytsem output, resource usage characteristics of the microservices 105, 106 to the observer 108. This allows the observer 108 to monitor the performance of the system in order to dynamically switch via scaling decisions between vertical scaling and horizontal scaling of the microservices 105, 106 using multiple scalers, such as a vertical scaler 109, based on the payload of the system.

In example method 500, the storage gateway microservice 105 reports input and resource metrics to an observer 108 in a fixed interval (block 505). These metrics are described above, and these metrics are received by the observer in example method 500 (block 510).

Example method 500 also includes receiving a request at the request queue of the storage gateway microservice 105. For example, a user may send a request to store a large video file which is received at the request queue 104 of a storage gateway microservice 105. Additionally, in an embodiment of the present disclosure, the metrics reporting of block 505 and 510 may not occur if there are no requests in the request queue 104 and no new request is received. Example method 500 further includes processing the request from the request queue 104 (block 520). For example, the storage gateway microservice 105 may perform compression on the large video file received in the request for storage. Alternatively, the storage gateway microservice 105 may simply pass the request to a storage backend microservice 106.

In example method 500, the storage backend microservice 106 stores or retrieves the object data related to the processed request according to the received request to or from a permanent storage (block 525). For example, the storage backend microservice 106 may write the data of the large video file to a hard disk storage. The example method 500 also may include notification of the storage gateway microservice 105 by the storage backend microservice 106 that the storage backend microservice 106 has completed the request. For example, the storage backend microservice 106 may send a notification to the storage gateway microservice 105, indicating that the storage backend microservice 106 completed writing the large video file to permanent storage. The example method 500 may further include reporting output metrics to the observer (block 530). For example, the storage gateway microservice 105 may report the response time of the system to the observer 108, measured as the time from when the request was received at the request queue (block 515) until the storage backend microservice 106 notifies the storage gateway microservice 105 that it has competed storing of the large video file (block 528). Example method 500 may also include reporting by the storage backend microservice 106 on its resource usage to the observer 108 (blocks 535 and 540). For example, the storage backend microservice 106 may report its processing device utilization percentage to the observer 108.

Example method 500 may include the determining of a scaling decision based on the received metrics by the observer 108 (block 545). For example, the observer 108 may calculate that writing a large video file to storage is a resource intensive process for the storage backend microservice 106, given the payload of the system, and determine a scaling decision to allocate more computing resources to the storage backend microservice 106. The observer 108 in example method 500 may then transmit the scaling decision which is received by at least one scaler (blocks 550 and 555), such vertical scaler 109. For example, the observer 108 may transmit a scaling decision to a vertical scaler 109 that includes allocating more computing resources for the storage backend microservice 106. Example method 500 also may include a scaler, such as the vertical scaler 109, performing a scaling action (block 460). For example, the vertical scaler 109 may perform a scaling action that scales up the resources available to the storage backend microservice 106 in order to reduce the response time and improve system efficiency.

In additional embodiments of the present disclosure, in response to the system payload, an observer may determine and transmit a scaling decision that defines multiple scaling actions to be performed simultaneously by multiple scalers. For example, if the system receives a large number of requests all at once to the request queue 104 to store large video files that require compression, the observer 108 may determine based on the received metrics that the storage gateway microservice needs more allocated computing resources and more instances to efficiently service the request queue and improve system response time. In this instance, the observer 108 may transmit a scaling decision to both a vertical scaler 109 and horizontal scaler 110, which coordinates the scaling actions to be performed by the scalers such that the scalers do not interfere with one another. The result of transmission of the scaling decision is the vertical scaler 109 performing a scaling action to increase the computing resources allocated to the storage gateway microservice 105 and the horizontal scaler 110 performing a scaling action to increase the number of instances of the storage gateway microservice 105 (the storage gateway microservice 105 is scaled “up” and “out” as a result of the scaling decision determined by the observer 108).

In additional embodiments of the present disclosure, the system payload may vary from the large amount of traffic requiring resource intensive processes (e.g. compression of video files) to a much lower amount of traffic comprising of requests to store text files that do not require any compression, encryption, or other processing intensive activity to be performed by the storage gateway microservice 105. In this instance, for example, the observer may determine based on the received metrics that the storage gateway microservice no longer requires the additional computing resources or additional instances it was previously scaled to have. As such, the observer may transmit a scaling decision to both a vertical scaler 109 and horizontal scaler 110, which coordinates the scaling actions to be performed by the scalers such that the scalers do not interfere with one another. The result of transmission of the scaling decision is the vertical scaler 109 performing a scaling action to decrease the computing resources allocated to the storage gateway microservice 105 and the horizontal scaler 110 performing a scaling action to decrease the number of instances of the storage gateway microservice 105 (the storage gateway microservice 105 is scaled “down” and “in” as a result of the scaling decision determined by the observer 108) in order for the system resources to be more efficiently allocated.

In additional embodiments of the present disclosure, the system payload may vary from a steady stream of requests requiring resource intensive processes (e.g. compression of video files) to a much greater amount of traffic comprising of requests to store text files that do not require any compression, encryption, or other processing intensive activity to be performed by the storage gateway microservice 105. In this instance, for example, as the system is processing the requests to compress video files, the observer 108 may determine based on the received metrics that the storage gateway microservice 105 requires additional computing resources and transmit a scaling decision to the vertical scaler 109 to perform a scaling action that allocates more resources to the storage gateway microservice 105. As the payload characteristics change to a larger amount of traffic comprised of text requests that do not require compression, the observer 108 may determine based on the received metrics that the storage gateway microservice 105 no longer requires the additional computing resources it was previously scaled to have but also requires more instances to more quickly service the request queue 104. As such, the observer may transmit a scaling decision to both a vertical scaler 109 and horizontal scaler 110, which coordinates the scaling actions to be performed by the scalers such that the scalers do not interfere with one another. The result of transmission of the scaling decision is the vertical scaler 109 performing a scaling action to decrease the computing resources allocated to the storage gateway microservice 105 and the horizontal scaler 110 performing a scaling action to increase the number of instances of the storage gateway microservice 105 (the storage gateway microservice 105 is scaled “down” and “out” as a result of the scaling decision determined by the observer 108) in order for the system resources to be more efficiently allocated.

In additional embodiments, the observer 108 may transmit a scaling decision to multiple scalers, such as the vertical scaler 109 and horizontal scaler 110, which results in the vertical scaler 109 scaling up the resources allocated to the storage backend microservice 106 and in the horizontal scaler 110 scaling out the instances of the storage backend microservice 106. Additional embodiments of the present disclosure may include the observer 108 determining a scaling decision that results in different combinations of scaling actions performed on the storage backend microservice by the horizontal and vertical scalers simultaneously in order to adapt to the payload characteristics of the system (e.g. the storage gateway microservice 105 is scaled “down and in” or “down and out” or “up and in” as a result of the scaling decision determined by the observer 108).

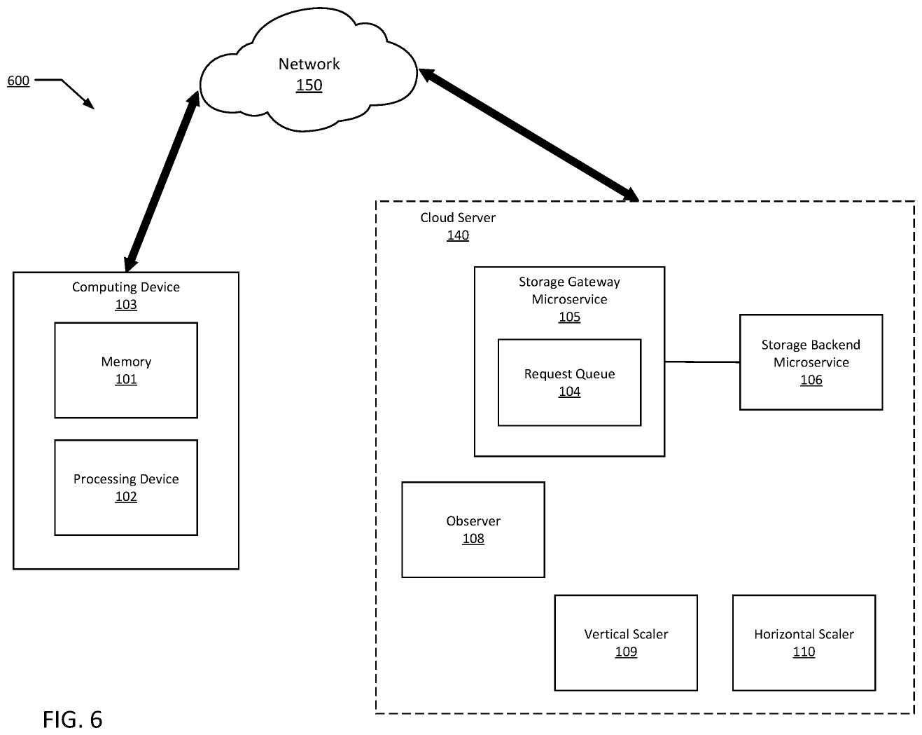

FIG. 6 illustrates an example embodiment of a system for dynamically switching between horizontal and vertical autoscalers to dynamically adapt to the payload of the system 600, in which at least the storage gateway microservice 105, storage backend microservice 106, observer 108, vertical scaler 109, and horizontal scaler 110 are hosted on a cloud server 140, which a computing device 103 housing a memory 101 in communication with at least one processing device 102 accesses over a network 150, for example, the Internet.

In additional embodiments of the present disclosure, the system of FIG. 1 may be adapted to microservices configured to perform block storage. However, as operations in block storage occur more frequently, tuning of the system is much more challenging. As such, the advantages of the present disclosure are particularly advantageous when applied to object storage.

In autoscaling known in the art, vertical and horizontal scalers generally operate independently which can result in issues and inefficiencies for the computing system. As a result of a system dynamically switching between vertical and horizontal scalers, according to an aspect of the present disclosure, autoscaling is performed efficiently which results in improvements to hardware utilization, energy reduction for processing and memory devices, system robustness and downtime, etc. An observer monitors multiple microservices through receiving metrics on the system performance from the microservices. Using these metrics from multiple microservices, the observer is able to efficiently coordinate the vertical and horizontal scaling of system resources in order to improve the system throughput, reduce latency, and minimize system inefficiency, for example by reducing the amount of time it takes for a storage gateway microservice, a storage backend microservice, or both to process and complete storage requests.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be configured to be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims. To the extent that any of these aspects are mutually exclusive, it should be understood that such mutual exclusivity shall not limit in any way the combination of such aspects with any other aspect whether or not such aspect is explicitly recited. Any of these aspects may be claimed, without limitation, as a system, method, apparatus, device, medium, etc.

The invention is claimed as follows:

1. A system for comprising:
a memory;
at least one processing device configured to:
receive a request at a request queue of a storage gateway microservice;
process the request at the storage gateway microservice;
store or retrieve data related to the processed request using a storage backend microservice; and
report to an observer, in a fixed interval, input metrics, output metrics, and resource usage metrics related to the processing of the request and the storing or retrieving of data, wherein the observer is configured to:
determine a scaling decision and
transmit the scaling decision to a scaler which performs a scaling action on the storage gateway microservice, the storage backend microservice, or both based on the scaling decision.

2. The system of claim 1, wherein the scaling decision includes of multiple scaling decisions transmitted by the observer to multiple scalers to take multiple scaling actions.

3. The system of claim 1, wherein the observer is configured to transmit the scaling decision to at least one of a vertical scaler or a horizontal scaler based on the scaling decision.

4. The system of claim 1, wherein the fixed interval is configured to either increase or decrease based on changes in the reported metrics.

5. The system of claim 1, wherein the storage gateway microservice is configured to compress or decompress data related to a request when processing the request.

6. The system of claim 1, wherein the storage gateway microservice is configured to encrypt or decrypt data related to a request when processing the request.

7. The system of claim 1, wherein determining a scaling decision includes calculating whether a value for an input, output, or resource usage metric has exceeded a threshold value.

8. A method comprising:
receiving a request at a request queue of a storage gateway microservice;
processing the request at the storage gateway microservice;
storing or retrieving data related to the request using a storage backend microservice;
reporting to an observer, in a fixed interval, input characteristics, output characteristics, and resource usage characteristics related to the processing of the request and storing or retrieving of data, wherein the observer is configured to:
determine a scaling decision based on the reported metrics and
transmit the scaling decision to a scaler, which performs a scaling action on the storage gateway microservice, the storage backend microservice, or both based on the scaling decision.

9. The method of claim 8, wherein the scaling decision comprises multiple scaling decisions transmitted by the observer to multiple scalers to take multiple scaling actions

10. The method of claim 8, wherein the observer is configured to transmit the scaling decision to a vertical scaler or a horizontal scaler based on the scaling decision.

11. The method of claim 8, wherein processing the request includes compressing or decompressing data related to the request.

12. The method of claim 8, wherein processing the request includes encrypting or decrypting data related to the request.

13. The method of claim 8, further comprising adjusting the fixed interval based on changes in the reported metrics.

14. The method of claim 8, wherein determining a scaling decision includes calculating whether a value for an input, output, or resource usage metric has exceeded a threshold value.

15. A non-transitory computer readable medium storing instructions, which when executed by a processor, are configured to cause the processor to:
receive a request at a request queue of a storage gateway microservice;
process the request at the storage gateway microservice;
store or retrieve data related to the processed request using a storage backend microservice;
report input metrics, output metrics, and resource usage metrics related to the processing of the request and storing or retrieving of data to an observer, wherein the observer is configured to determine a scaling decision based on the reported metrics and transmit the scaling decision to a scaler.
